(19) United States
(12) Patent Application Publication
(10) Pub. No.: US 2026/0209449 A1
(43) Pub. Date: Jul. 23, 2026

(54) Cross-linked Polyphosphazene-Polysiloxane Polymer for Gas Separation

(71) Applicant: United States Department of Energy, Washington, DC (US)

(72) Inventors: David P. Hopkinson, Morgantown, WV (US); Lingxiang Zhu, Canonsburg, PA (US); Victor Kusuma, Pittsburgh, PA (US)

(21) Appl. No.: 19/456,047

(22) Filed: Jan. 22, 2026

Related U.S. Application Data
(60) Provisional application No. 63/747,995, filed on Jan. 22, 2025.

(51) Int. Cl. C08J 3/24; B01D 53/22; B01D 67/00; B01D 69/06; B01D 69/08; B01D 69/10; B01D 69/12; B01D 71/70; C08J 5/18

(52) U.S. Cl. CPC C08J 3/24; B01D 53/228; B01D 67/0013; B01D 69/06; B01D 69/08; B01D 69/10; B01D 69/1216; B01D 71/70; C08J 5/18; B01D 2053/222; B01D 2053/224; B01D 2256/10; B01D 2256/245; B01D 2257/104; B01D 2257/504; C08J 2385/02; C08J 2483/06

(57) ABSTRACT

One or more embodiments relates to a method of synthesizing a cross-linked polymer blend material suitable for gas separation applications. The method includes providing a blend of one or more polyphosphazene polymers containing vinyl groups (—CH═CH₂); and providing a polysiloxane containing reactive silicon-hydrogen (Si—H) bonds. Additionally, the method includes cross-linking the polyphosphazene polymer blend and the polysiloxane through a hydrosilylation reaction, forming the cross-linked polymer blend material.

### CROSS-REFERENCE TO RELATED APPLICATIONS

This application claims the benefit of and priority to U.S. Patent Application Ser. No. 63/747,995 filed Jan. 22, 2025, the complete subject matter of which is incorporated herein.

### STATEMENT OF GOVERNMENT INTEREST

The United States Government has rights in this invention pursuant to the employer-employee relationship of the Government to the inventors as U.S. Department of Energy employees and site-support contractors at the National Energy Technology Laboratory.

### PRIOR ART

U.S. Pat. No. 7,074,256 B2 to Stewart et al. entitled “Phosphazene membranes for gas separations” describes the use of polyphosphazenes with alkoxylated MEE derivative side groups for gas separations, specifically CO₂ from non-polar gases (such as N₂, CH₄, Ar, CO, H2, and He).

U.S. Pat. No. 5,457,160 to Allcock et al entitled “Polyphosphazene blends” describes the preparation of polymer blends that include polyphosphazene containing 2-(2-methoxyethoxy) ethanol pendant groups (referred as MEEP polymer, such as poly [bis-(2-(2-methoxy) ethoxy) ethoxyphosphazene]) and its cross-linked versions, where cross-linking can be achieved by homolysis of aliphatic C—H or C—Cl bonds to increase the structural integrity of the blend material.

U.S. Pat. No. 4,710,204 to Kraus et al entitled “Polyphosphazene gas separation membranes” discloses using a halogenated polyphosphazenes, such as a poly(fluoroalkoxy) polyphosphazene, to separate CO₂ and H₂S from a methane feed stream that includes CO₂, H₂S, and CH₄.

U.S. Pat. No. 4,728,345: Murphy, MK: “Multicomponent gas separation membranes having polyphosphazene coatings” describes gas separation application (primarily CO₂/CH₄ separation) as a porous hollow fiber supported polyphosphazene coating layer with polyphosphazene's side groups selected from alkyl, aryl, substituted alkyl and substituted aryl.

Orme, C J; Harrup, M K; Luther, T A; Lash, R P; Houston, K S; Weinkauf, D H; Stewart, F F: document entitled “Characterization of gas transport in selected rubbery amorphous polyphosphazene membranes”, Journal of Membrane Science 186, 249-256 (2001) describes gas permeability of a MEEP polymer family where MEE substituents ranging from 6 to 100 mol % providing CO₂/N₂ separation performance, 2-AP substituents up to 19 mol % for cross-linking functionality, and 4-methoxyphenol up to 75 mol % for mechanical strength.

Orme, C J; Klaehn, J R; Harrup, M K; Luther, T A; Peterson, E S; Stewart, F F: document titled “Gas permeability in rubbery polyphosphazene membranes”, Journal of Membrane Science 280, 175-184 (2006) describes the gas permeability of four more ethoxylated polyphosphazene polymers without MEE substituents.

Orme, C. J., McNally, J. S., Klaehn, J. R. and Stewart, F. F., document titled “Mixed substituent ether-containing polyphosphazene/poly (bis-phenoxyphosphazene) blends as membranes for CO2 separation from N2”, Journal of Applied Polymer Science 138, 50207 (2021) describes the gas permeability of physical blends of MEEP80/poly(bis-phenoxyphosphazene) without cross-linking.

Kusuma, V. A., McNally, J. S., Baker, J. S., Tong, Z., Zhu, L., Orme, C. J., Stewart, F. F. and Hopkinson, D. P., document titled “Cross-linked polyphosphazene blends as robust CO2 separation membranes”, ACS applied materials & interfaces 12, 30787-30795 (2020) discloses cross-linking MEEP-based polymers using thiol-ene photopolymerization chemistry.

### BACKGROUND OF THE INVENTION

Gas separation using polymeric membranes is an energy-efficient and commercially-viable alternative to the well-established but energy-intense separation processes such as solvent absorption, pressure-swing adsorption, and distillation. Since the 1980s, polymeric membranes have been commercialized for CO₂ removal from natural gas, production of high-purity N₂ from air, and H₂ recovery from ammonia purge gas. The past decade has seen a rapidly growing market for CO₂ capture from power generation and industrial point sources for applications such as enhanced oil recovery. CO₂ removal from flue gases of those point sources primarily involves CO₂/N₂ separation.

Numerous reported membrane materials primarily focus on the materials' intrinsic CO₂/N₂ separation performance (i.e., CO₂ permeability and CO₂/N₂ selectivity) as a bulk film. However, the membrane materials' ability to form thin films and their long-term performance stability (or non-aging property) in this form are usually overlooked. Meanwhile, for practical applications, membrane materials must be engineered into sub-micron-thick films to enable rapid transport of gas molecules across the membranes. To date, only one CO₂/N₂ separation membrane (Polaris™ membrane of Membrane Technology and Research, Inc.) has been commercialized for CO₂ capture from N₂-rich flue gases, because it is difficult to identify and then synthesize a functioning polymer with high CO₂ permeability, high CO₂/N₂ selectivity, excellent thin film forming ability, and long-term performance stability in a thin film state.

A need exists in the art for a class of cross-linked polyphosphazene-polysiloxane polymers that produce a practically useful CO₂/N₂, CO₂/CH₄, and/or O₂/N₂ separation membrane.

### SUMMARY OF THE INVENTION

One object of at least one embodiment is related to cross-linked polyphosphazene-polysiloxane polymers that produce a practically useful CO₂/N₂, CO₂/CH₄, and/or O₂/N₂ separation membrane.

One embodiment relates to a method of synthesizing a cross-linked polymer blend material suitable for gas separation applications. The method includes providing a blend of one or more polyphosphazene polymers containing vinyl groups (—CH═CH₂); and providing a polysiloxane containing reactive silicon-hydrogen (Si—H) bonds. Additionally, the method includes cross-linking the polyphosphazene polymer blend and the polysiloxane through a hydrosilylation reaction, forming the cross-linked polymer blend material.

One or more embodiments include the polyphosphazene polymer having a structure with at least a pendant R₁ group containing a vinyl group containing (—CH═CH₂) and at least a pendant group of 2-(2-methoxyethoxy) ethanol (MEE) group. The molar ratio of the substituent MEE and R₁ groups is y/x>2, such that the molar ratio of the substituent MEE and R₁ groups is greater than 5.

Additional embodiments of the method include the vinyl containing R₁ pendant group 2-allylphenoxy (2-AP) group. The polysiloxane has at least a reactive Si—H bond. The polysiloxane can include poly(dimethylsiloxane-co-methylhydrosiloxane), while the cross-linked polymer blend is a cross-linked polyphosphazene-polysiloxane polymer. Embodiments may include the hydrosilylation reaction catalyzed by noble metals selected from the group comprising platinum (Pt), rhodium (Rh), iridium (Ir), and Ruthenium (Ru) catalysts.

Further embodiments include the Pt catalyst is a platinum-divinyltetramethyldisiloxane complex, where the platinum-divinyltetramethyldisiloxane complex is between about 1 and about 102 ppm levels relative to reaction mixtures. The hydrosilylation reaction takes place at between 0° C. and 100° C. for 1 to 1500 minutes and takes place in an organic solvent selected from the group comprising toluene, benzene, hexane, pentane, iso-octane, chloroform, diethyl ether, tetrahydrofuran, and their mixtures.

Yet another embodiment relates to a method of separating a gas from a gas mixture. The method includes contacting a cross-linked polyphosphazene-polysiloxane polymer with the gas mixture comprising at least one of CO₂, N₂, O₂ and CH₄; and allowing at least a portion of the gas mixture to permeate and pass through the polymer, whereby at least a portion of the CO₂/N₂, or CO₂/CH₄, or O₂/N₂ is separated from the gas mixture.

In one or more embodiments, the cross-linked polyphosphazene-polysiloxane polymer is cast into a polymer membrane form, a thin film composite membrane for example, where the thin film includes at least a cross-linked polyphosphazene-polysiloxane polymer layer as the selective layer; and at least a porous support layer on the bottom providing the mechanical strength. Embodiments contemplate an intermediate polydimethylsiloxane gutter layer, allowing the formation of a thin selective layer, between 10 nanometers and 10 micrometers for example, on the porous support layer.

In at least one embodiment, the cross-linked polyphosphazene-polysiloxane porous support layer is selected from the group comprising a flat-sheet and a hollow fiber. Embodiments further include the polymer membrane is formed by mixing the polyphosphazene-polysiloxane polymer matrix with a filler particle, where the filler particle consists of a material selected from the group comprising metal organic framework, carbon molecular sieve, porous organic polymer, graphene, graphene oxide, and silica gel.

### BRIEF DESCRIPTION OF DRAWINGS

The invention together with the above and other objects and advantages will be best understood from the following detailed description of the preferred embodiment of the invention shown in the accompanying drawings, wherein:

FIG. 1 depicts a reaction scheme for cross-linking a MEEP polymer using polydimethylsiloxane (PDMS) based cross-linkers with methylhydrosiloxane (—CH₃(H)Si—O—) groups (also referred as methylhydrosiloxane-PDMS) to form cross-linked PDMS-MEEP polymers;

FIG. 2 depicts one embodiment of a thin film composite (TFC) membrane adapted to separate a gas from a gas mixture;

FIG. 3 depicts images of a vial of uncross-linked MEEP95 polymer with 95% mole % MEE as its pendant groups in a high-viscosity semisolid form, and a free-standing cross-linked and solidified PDMS-MEEP polymer film;

FIG. 4 depicts a high-level schematic of one method of producing bulk films and thin film composite (TFC) membranes;

FIG. 5 depicts a graph illustrating a comparison of pure-gas CO₂/N₂ separation performance of a spin-coated PDMS-MEEP TFC and a wire-wound rod coated PDMS-MEEP TFC with commercially available membranes, the selected 15PDMS-MEEP has 15 mass % PDMS and 85 mass % MEEP;

FIG. 6 depicts a graph illustrating the benchmark of a wire-wound rod coated 15PDMS-TFC, commercially available membranes, and lab-scale membranes in a cost analysis for a membrane-based coal flue gas decarbonization system in a coal power plant;

FIG. 7 depicts a graph illustrating changes in Si—H characteristic peaks in FT-IR spectra of methylhydrosiloxane-PDMS crosslinkers and various cross-linked PDMS-MEEP films;

FIG. 8 depicts a graph illustrating changes in C═C characteristic peaks in FT-IR spectra of uncross-linked MEEP95 and various cross-linked PDMS-MEEP films;

FIG. 9 depicts a graph illustrating both pure-gas and mixed-gas CO₂/N₂ separation performance of PDMS-MEEP bulk films with varying PDMS contents of 8-34 wt. %,

FIG. 10 depicts a graph illustrating a benchmark of pure-gas CO₂/N₂ separation performance of 15PDMS-MEEP bulk films prepared from MEEP95 in different molecular weights in the Robeson's upper bound plot;

FIG. 11 depicts a graph illustrating a benchmark of mixed-gas CO₂/N₂ separation performance of a 15PDMS-MEEP bulk film at different operation temperatures (22° C.-60° C.) in the Robeson's upper bound plot;

FIG. 12 depicts a graph illustrating the effect of relative humidity (RH, 0-95%) on the mixed-gas CO₂/N₂ separation performance of a MEEP95 #2 based 15PDMS-MEEP bulk film;

FIG. 13 depicts a graph plotting a 15PDMS-MEEP bulk film's CO₂ permeability, CO₂/N₂ selectivity, feed gas composition, and temperature as a function of test time over a course of 360 hours using actual flue gas with varying CO₂ concentrations of 4.5-9 mol % from a natural gas fired boiler and a coal fired boiler at the National Carbon Capture Center, Wilsonville, Alabama; and

FIG. 14 depicts a graph illustrating performance stability on a wire-wound rod coated 15PDMS-MEEP TFC for 1000 hours in a lab-testing.

### DETAILED DESCRIPTION OF THE INVENTION

The foregoing summary, as well as the following detailed description of certain embodiments of the present invention, will be better understood when read in conjunction with the appended drawings.

The following detailed description should be read with reference to the drawings in which similar elements in different drawings are numbered the same. The drawings, which are not necessarily to scale, depict illustrative embodiments and are not intended to limit the scope of the invention.

MEEP polymers bearing a large number of ether oxygens that favorably interact with quadrupolar CO₂ against N₂ have shown great potential as CO₂/N₂, CO₂/CH₄, and/or O₂/N₂ separation material. However, these MEEP polymers tend to have very weak integrity because they have low glass transition temperature (T_{g}<−60° C.) values. At room temperature, they behave as high-viscosity semisolids that cannot be cast into functioning membranes for gas separation applications.

Previous attempts, including UV-radiation, free-radical thermal cross-linking using azobisisobutyronitrile, and thiol-ene photopolymerization, have been explored to solve the above-mentioned problem. These methods were employed to cross-link MEEP polymers to form robust films with considerably good CO₂/N₂ separation performance, but the resulting cross-linked polymers can hardly be fabricated into functioning yet scalable thin film composite (TFC) membranes.

One or more embodiments relates to a class of cross-linked polyphosphazene-polysiloxane polymers that can form a practically useful CO₂/N₂, CO₂/CH₄, and/or O₂/N₂ separation membrane. The novel cross-linked polyphosphazene-polysiloxane polymers are synthesized via a facile hydrosilylation reaction to covalently bond a 2-(2-methoxyethoxy) ethanol containing polyphosphazene with commercial polysiloxane cross-linkers. Embodiments include the fabrication of bulk films and thin film composite (TFC) membranes using the obtained cross-linked polymers adapted to perform CO₂/N₂, CO₂/CH₄, and/or O₂/N₂ separation.

One or more embodiments include a method of solidifying a cross-linkable polyphosphazene polymer (referred to as MEEP) containing 2-(2-methoxyethoxy) ethanol (MEE) groups from a viscous semisolid state into robust free-standing bulk films or supported sub-micron thin films for gas separation applications through a hydrosilylation cross-linking strategy. In one embodiment, this includes synthesizing a cross-linked polymer blend material suitable for gas separation applications, including providing a blend of one or more polyphosphazene polymers containing vinyl groups (—CH═CH₂); providing a polysiloxane containing reactive silicon-hydrogen (Si—H) bonds; and cross-linking the polyphosphazene blend and the polysiloxane through hydrosilylation reaction, forming the cross-linked polymer blend material.

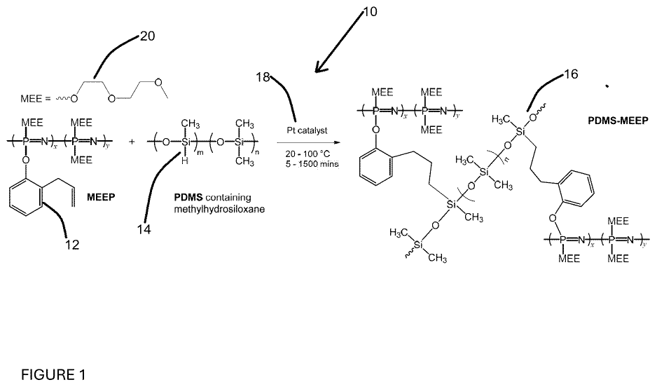

FIG. 1 depicts a reaction scheme 10 for cross-linking MEEP 12 having MEE 20 using polydimethylsiloxane (PDMS) based cross-linkers 14 with methylhydrosiloxane groups to form cross-linked PDMS-MEEP polymers 16. Pt catalyst 18 is a platinum-divinyltetramethyldisiloxane complex at 10-102 ppm levels. While a Pt catalyst is disclosed, rhodium (Rh), iridium (Ir), and Ruthenium (Ru) catalysts are also contemplated. In at least one embodiment, cross-linkable MEEP contains 2-(2-methoxyethoxy) ethanol (MEE) and 2-allylphenol (2-AP) groups. When x=0.1 and y=0.9, the MEEP structure as shown is MEEP95, comprised of 95 mol % MEE 20 and 5 mol % 2-AP substituents.

As provided previously, embodiments are contemplated in which the hydrosilylation reaction is catalyzed by noble metals selected from the group comprising platinum (Pt), rhodium (Rh), iridium (Ir), and Ruthenium (Ru) catalysts. In embodiments where the Pt catalyst is used, the Pt catalyst is a platinum-divinyltetramethyldisiloxane complex, where used platinum-divinyltetramethyldisiloxane complex is between about 1 and about 102 ppm levels relative to reaction mixtures. Embodiments are contemplated in which the hydrosilylation reaction takes place at between 0° C. and 100° C. for 1 to 1500 minutes. Additional embodiments contemplate that the hydrosilylation reaction takes place in an organic solvent selected from the group comprising toluene, benzene, hexane, pentane, iso-octane, chloroform, diethyl ether, tetrahydrofuran, and their mixtures.

As illustrated in FIG. 1, one or more embodiments of the invention uses the organoplatinum compound catalyzed hydrosilylation reaction 10 to effectively cross-link MEEP polymers in both bulk film and thin film states, producing both high-performance stand-alone bulk films and TFC membranes. The reaction is more effective than previous attempts because it is subject to very few reaction condition limitations and takes place over a wide temperature range (0° C. to 100° C.) and a wide curing time window (1 min-1500 minutes), although other temperatures and curing times are contemplated. The cross-linking reaction can also be tunable before (i.e., polymers dissolved in solution) and during the membrane casting (i.e., polymers start curing).

More specifically, embodiments use high MEE containing MEEP95 as a base polymer that has about 95 mol % MEE substituents on the polyphosphazene's P═N backbone and about 5 mol % 2-allylphenol (AP) substituents. The 2-AP groups are cross-linkable by numerous polydimethylsiloxane (PDMS) based cross-linkers with silicon-hydrogen (Si—H) groups. During the reaction, Si—H groups of PDMS based cross-linkers 14 reacts with C═C of 2-AP groups to covalently bond MEEP polymer chains, resulting in firmly cross-linked PDMS-MEEP polymers 16.

In accordance with one embodiment, a cross-linked polymer blend material is synthesized. This method includes providing a blend of one or more polyphosphazene polymers containing vinyl groups (—CH═CH₂) and providing a polysiloxane containing reactive silicon-hydrogen (Si—H) bonds. The polyphosphazene polymer blend and the polysiloxane are cross-linked through a hydrosilylation reaction, forming the cross-linked polymer blend material.

In at least one embodiment, the polyphosphazene polymer has a structure with at least a pendant R₁ group containing a vinyl (—CH═CH₂) group and at least a pendant group of 2-(2-methoxyethoxy) ethanol (MEE) group illustrated in STRUCTURE 1:

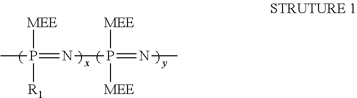

The vinyl (—CH═CH₂) group of the polyphosphazene polymer is located within an R₁ pendant group 2-allylphenoxy (2-AP) group as illustrated in STRUCTURE 2:

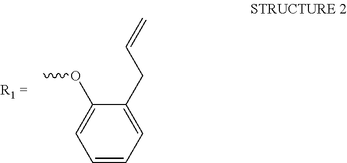

And the MEE group has the structure illustrated in STRUCTURE 3.

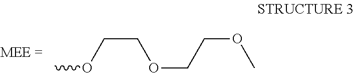

The polysiloxane has at least a reactive Si—H bond in the structure illustrated in STRUCTURE 4.

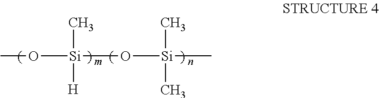

The cross-linked polymer blend comprises a cross-linked polyphosphazene-polysiloxane polymer having the structure illustrated in STRUCTURE 5:

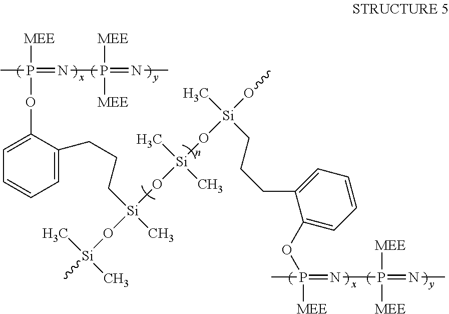

It is contemplated that, in one embodiment, the molar ratio of the substituent MEE and R₁ groups is y/x>2 such that the molar ratio of the substituent MEE and R₁ groups is greater than 5. It is further contemplated that the polysiloxane includes poly(dimethylsiloxane-co-methylhydrosiloxane).

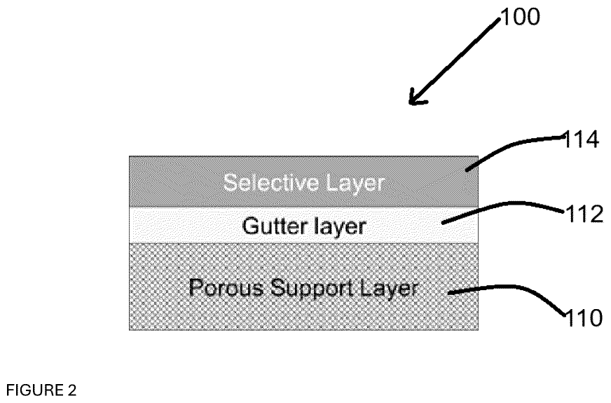

One embodiment of the invention relates to a polymer membrane or film, a thin film, or a bulk film, for example. One embodiment of film 100 is illustrated in FIG. 2. FIG. 2 depicts film 100 includes a porous support layer 110, gutter layer 112 in contact with the porous support layer 110, and a selective layer 114 in contact with at least the gutter layer 112. In at least one embodiment, the selective layer 114 is at least a cross-linked polyphosphazene-polysiloxane polymer layer, gutter layer 112 is at least an intermediate polydimethylsiloxane gutter layer, allowing the formation of a thin selective layer on the porous support layer, while the porous support layer provides mechanical strength for the file 100.

Embodiments are contemplated in which the selective layer 114 is between about 10 nanometers and about 10 micrometers. Further, while the cross-linked polyphosphazene-polysiloxane porous layer is a flat-sheet and/or a hollow fiber. Additionally, the polymer membrane is formed by mixing the polyphosphazene-polysiloxane polymer matrix with a filler particle, where the filler particle consists of a metal organic framework, a carbon molecular sieve, a porous organic polymer, graphene, graphene oxide, and/or a silica gel.

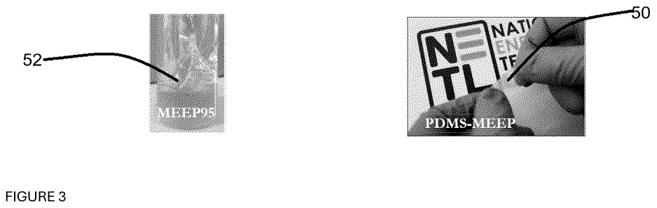

FIG. 3 depicts images of one embodiment of a 15PDMS-MEEP bulk film 50 with robust and non-tacky features versus uncross-linked MEEP95 52 in the form of flowing semi-solid. In the illustrated embodiment, 30-150 μm-thick free-standing bulk films were prepared via solution casting. 4 g PDMS-MEEP/toluene solution resulting from the above-mentioned synthesis route was poured into an aluminum-ring mold sitting on a polypropylene substrate. At least 16 h was allowed for slow solvent evaporation at 23° C. before peeling the formed bulk film off the substrate. The obtained bulk film was further cured at 100° C. for 30 mins and then collected for characterizations. Casting solution volume can be changed or different mold sizes (1″, 1.5″, or 2″ in diameter) can be used to achieve different film thicknesses.

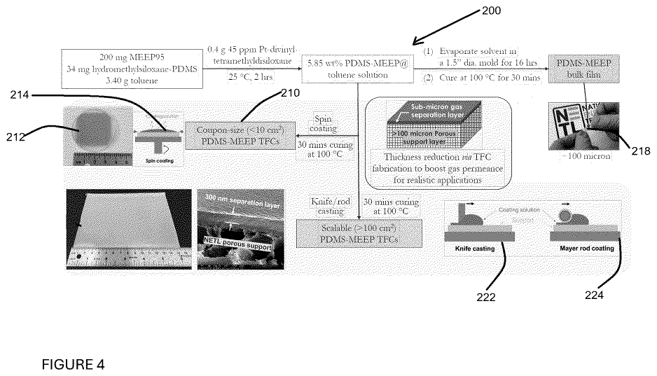

Various methods are contemplated for fabricating the film composite, such as the thin-film composite (TFC) previously described and the bulk film 218. FIG. 4 illustrates embodiments for preparing bulk film and TFC membranes generally designated 200. Sub-micron thin film composite membranes can be fabricated by different coating methods including spin coating 214 and wire-wound rod (or Mayer rod) coating 224 due to the good thin-film forming ability of the obtained PDMS-MEEP.

In both instances, a ca. 100 nm PDMS layer coated polybenzimidazole (PBI) porous support was used as a coating substrate. In preparing the PBI supports, a 3 mL 10 wt. % PBI solution dissolved in dimethylacetamide was first cast on non-woven fabrics using a 4″-wide casting knife with a gap setting of 150 μm and a knife speed of 4 cm s⁻¹ at 23° C. and relative humidity of 60%. An evaporation period of 5 s was allowed before immersing the PBI into a water quench bath set at 60° C. After 1 hour, the resulting membrane was rinsed twice in a 4 L deionized water tank. The 4×6″ PBI support was finally obtained after air-drying at 23° C. in a fume hood for 24 hours. PDMS coated PBI membranes were then fabricated 222 via knife casting of 0.5 wt. % PDMS/hexane coating solutions on a PBI support using a 4″ wide casting knife with 30 μm clearance above the support. The PDMS/PBI composite membrane was collected for use after curing in an oven at 100° C. for 1 hour.

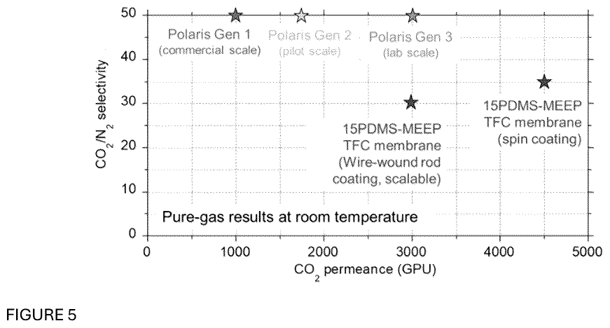

Coupon size (<10 cm²) PDMS-MEEP TFC membranes 212 were facilely fabricated via spin coating. A 4 g ~5.0 wt. % 15PDMS-MEEP/toluene solution, resulting from above-mentioned PDMS-MEEP synthesis route, was diluted to 2.0 wt. % after the 2-h stirring. 0.5 mL coating solution was applied onto a 3×3 cm PDMS coated PBI support at a spin speed of 1000 rpm for 30 sec, followed by 30 mins curing at 100° C. The resulting ca. 120 nm 15PDMS-MEEP TFC membrane showed pure-gas CO₂ permeance as high as 4,500 gas permeation units (GPU) accompanied by CO₂/N₂ selectivity of 34 at 22° C., which is 50% higher in CO₂ permeance than the other known commercially available membranes (the Polaris membrane for example) through lower selectivity (See FIG. 5).

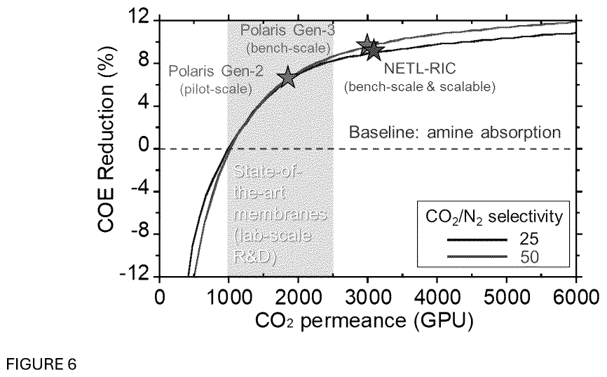

Bench-scale (>100 cm²) PDMS-MEEP TFC membranes can be fabricated via wire-wound rod coating, which is scalable in a roll-to-roll process. Briefly, 4 g of ~5.0 wt. % 15PDMS-MEEP/toluene solution, resulting from above-mentioned PDMS-MEEP synthesis route, was diluted to 1.0 wt. % after the 2 h stirring. 1 mL coating solution was applied onto a 4×6″ PDMS coated PBI support using a 50 micron wire-wound rod, followed by 30 mins curing at 100° C. The resulting ca. 300 nm 15PDMS-MEEP TFC membrane showed pure-gas CO₂ permeance as high as 3,000 GPU with CO₂/N₂ selectivity of 30 at 22° C., which is equal to the latest lab-scale Polaris membrane though with lower selectivity (see FIG. 5). In a cost analysis of a membrane-based process for capturing CO₂ from a coal-fired power plant, the performance of this scalable 15PDMS-MEEP TFC is comparable to that of the lab-scale Polaris membranes still under development and superior to that of the pilot-scale Polaris membranes. As shown in FIG. 6, this 15PDMS-MEEP TFC maintained high separation performance in 1000 h monitoring and showed non-aging behavior in a thin film state, endorsing the great potential for practical CO₂/N₂ separation applications.

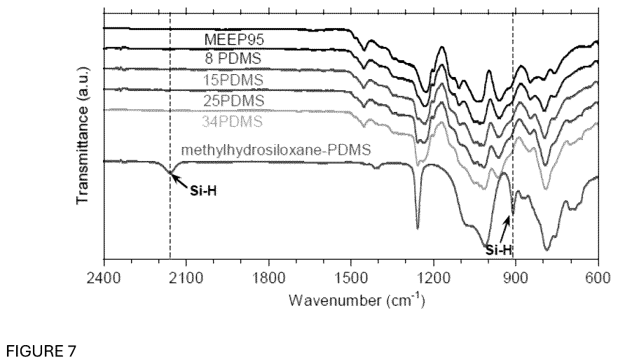

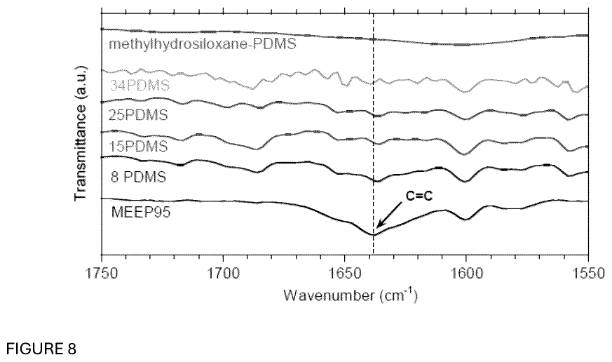

Fourier-transform infrared spectroscopy (FT-IR) was performed to understand the chemical changes of MEEP95 and methylhydrosiloxane-PDMS cross-linkers before and after the reaction. As shown in the graphs illustrated in FIGS. 7 and 8, the disappearance of Si—H characteristic peaks at 2156 and 906 cm⁻¹ and the diminishing of C═C characteristic peak at 1638 cm⁻¹ confirm the hydrosilylation reaction occurring between C═C of MEEP95 and Si—H of methylhydrosiloxane-PDMS cross-linkers.

Specifically, FIG. 7 depicts changes in Si—H characteristic peaks while FIG. 8 depicts a C═C characteristic peak in FT-IR spectra during the cross-linking reaction for four different PDMS-MEEP polymers. The effect of cross-linking on glass transition temperature (T_{g}) and mechanical strength of PDMS-MEEP polymers was studied using differential scanning calorimetry (DSC) and dynamic mechanical analysis (DMA), respectively. As shown in Table 1, cross-linking has minimal effect on the T_{g} of PDMS-MEEP polymers even though the values slightly increase with the increasing PDMS content, from −74.9° C. for 8PDMS-MEEP to −72.6° C. for 34PDMS-MEEP. All the values are still well below 0° C., demonstrating they are completely rubbery, which is a thermodynamically stable state, at room temperature (~23° C.). Also shown in Table 1, elastic moduli of PDMS-MEEP samples generally increase with increasing PDMS content, except for 25PDMS-MEEP. Elastic moduli of >0.3 MPa indicate the obtained PDMS-MEEP polymers should be handleable under most membrane fabrication conditions. Table 1 T_{g}, mechanical strength, and CO₂/N₂, CO₂/CH₄, and/or O₂/N₂ separation performance of four different χPDMS-MEEP, where χ is the PDMS content in wt. %, with the PDMS content varying from 8-34 wt %.

TABLE 1

| | Glass | | Pure-gas | |
|---|---|---|---|---|
| | transition | Elastic | CO₂ | |
| | temperature | modulus | permeability | CO₂/N₂ |
| Sample | (T_{g}, ° C.) | (MPa) | at 25° C.* | selectivity* |
| MEEP95 | −76.1 | | | |
| 8PDMS-MEEP | −74.9 | 0.30 | 626 | 37 |
| 15PDMS-MEEP | −74.8 | 0.43 | 844 | 35 |
| 25PDMS-MEEP | −74.6 | 0.33 | 1058 | 29 |
| 34PDMS-MEEP | −72.6 | 0.45 | 1240 | 25 |

Separation performance can be affected by the weight average molecular weight (M_{w}) of MEEP95 base polymer. The synthesis of PDMS-MEEP in Table 1 used MEEP95 with a M_{w} of 891 kDa.

For example, crude poly(dichlorophosphazene) (~30 g), prepared from the ring opening melt polymerization of hexachlorophosphazene, was dissolved in 300 ml anhydrous toluene under an argon atmosphere. Once dissolved, the polymer was precipitated by addition of 700 mL hexanes and the supernatant was reduced to dryness to determine the mass of polymer by difference. The purified poly(dichlorophosphazene) (18.9 g, 163 mmol) was re-dissolved in 300 mL anhydrous toluene under argon. In a separate flask, 2-allylphenol (2.18 g, 16.3 mmol) was dissolved in ~500 mL anhydrous THF under argon. NaH (60%, 650 mg, 16.2 mmol) was carefully added to the flask and the reaction was allowed to stir for 12 hrs. The polymer solution was poured into the phenoxide solution, and the reaction stirred for 24 hrs. In a separate flask, 2-(2-methoxyethoxy) ethanol (74.3 g, 619 mmol) was slowly added to a mixture of NaH (60%, 23.5 g, 588 mmol) in ~500 mL anhydrous THF. The reaction was allowed to stir for 18 hrs. The alkoxide reaction solution was added to the polymer via cannula, and the reaction was allowed to stir at room temperature for 24 hrs. The crude polymer was precipitated with the addition of 2 L hexanes, and then re-dissolved in 500 mL THF. The polymer was precipitated with 1 L hexanes and then dried in a vacuum oven at 50° C. overnight before being added to 700 mL H₂O. HCl (3 M) was used to neutralize, and then the mixture was heated to 70° C. without stirring. The precipitated polymer was collected and dissolved in 500 mL THF. The solution was centrifuged and decanted into 2 L hexanes to precipitate the purified polymer, which was dried in a vacuum oven at 50° C. Finally, 22.8 g (49% yield) purified MEEP95 was collected. 0.2 g MEEP95 was dissolved in 1.8 g toluene to form 10 wt. % solution. A desirable amount of PDMS cross-linkers in toluene, 0.4 g of 45 ppm Pt (platinum-divinyltetramethyldisiloxane complex) in toluene, and a desirable amount of toluene for the reaction solution volume adjustment were subsequently added into the MEEP95 solution. The resulting mixture (about 4 g) was stirred at room temperature (23° C.) for 2 h to allow the cross-linking reaction proceeding before membrane fabrications. The mixture can be gelled up after 24 h if it is not further diluted. To obtain cross-linked PDMS-MEEP with different PDMS contents, four PDMS cross-linkers with different methylhydrosiloxane functionalities were employed in this invention. Each methylhydrosiloxane group contains a reactive Si—H bond. Table 2 summarizes the required amounts of PDMS cross-linker solutions to fully cross-link MEEP95 at a batch size of 0.2 g MEEP95 used, and the resulting cross-linked polymers are denoted as χPDMS-MEEP, where χ is the PDMS content in wt. %. In all cases, 2-AP and methylhydrosiloxane were supplied in 1:1 molar ratio. Table 2 The required amounts of different types of PDMS cross-linker and their solutions to cross-link 2.0 g 10 wt % MEEP95 to prepare different PDMS-MEEP with the PDMS content varying from 8-34 wt %.

TABLE 2

| | Methyl- | | | Toluene |
|---|---|---|---|---|
| | hydrosiloxane | PDMS | PDMS/ | for reaction |
| PDMS- | content | Conc in | toluene | solution |
| MEEP | (mol %) in | toluene | solution | volume |
| type | PDMS | (wt %) | (g) | adjustment (g) |
| 8PDMS-MEEP | 26.8 | 2.0 | 0.85 | 0.75 |
| 15PDMS-MEEP | 16.0 | 5.0 | 0.68 | 0.92 |
| 25PDMS-MEEP | 10.7 | 7.5 | 0.85 | 0.75 |
| 34PDMS-MEEP | 5.4 | 10 | 1.02 | 0.58 |

Yet other embodiments relate to a method of separating a gas from a gas mixture. The method includes contacting a cross-linked polyphosphazene-polysiloxane polymer with the gas mixture including at least one of CO₂, N₂, O₂ and/or CH₄. The method further includes allowing at least a portion of the gas mixture to permeate and pass through the polymer, so that at least a portion of the CO₂/N₂, CO₂/CH₄, O₂/N₂ is separated from the gas mixture.

It should be appreciated that the method of separating the gas from the gas mixture using one of the films provides previously show an excellent combination of CO₂ permeability and CO₂/N₂, CO₂/CH₄, O₂/N₂ selectivity, in some cases, surpassing the 2008 Robeson's upper bound for CO₂/N₂ separation (i.e., the 2008 upper bound is a widely-used performance benchmarking, represents the highest CO₂/N₂ selectivity achievable for any given CO₂ permeability in polymers reported by Robeson in 2008), stable performance in the presence of water vapor, and durable and non-aging performance in a long-term (360 hours) field test in the real natural gas flue gas.

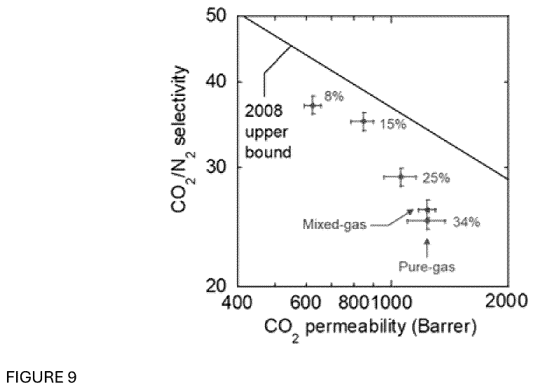

CO₂/N₂, CO₂/CH₄, O₂/N₂ separation performance of the obtained PDMS-MEEP bulk films was evaluated in an isochoric permeation system for pure-gas permeability/selectivity and an isobaric permeation system for mixed-gas permeability/selectivity. FIG. 9 depicts a graph illustrating both pure-gas and mixed-gas CO₂/N₂ separation performance of PDMS-MEEP bulk films with varying PDMS contents of 8-34 wt. %, and Table 1 provides pure-gas permeability/selectivity values. The PDMS-MEEP polymers exhibit promising separation properties near the 2008 Robeson's upper bound as shown in FIG. 9. Each data point represents averaged CO₂ permeability and CO₂/N₂ selectivity obtained from at least three film samples prepared in different batches. The permeability uncertainties are lower than 10% from batch to batch, and the selectivity uncertainties are less than 4%, demonstrating a good reproducibility of the developed methodology for PDMS-MEEP membrane fabrication and testing. Mixed-gas permeation measurement was also performed on the most permeable PDMS-MEEP membrane (i.e., 34PDMS-MEEP) in a simulated dry flue gas (14% CO₂/86% N₂). The membrane showed mixed-gas CO₂ permeability of 1245±100 Barrer and CO₂/N₂ selectivity of 26±1 at 25° C. These results are well aligned with its pure-gas CO₂ permeability of 1240±130 Barrer and CO₂/N₂ selectivity of 25±1, demonstrating the CO₂/N₂ separation performance of PDMS-MEEP in mixed-gas is as stable as that in pure-gas. 15PDMS-MEEP with high CO₂ permeability combined with high CO₂/N₂ selectivity positions itself the closest to the Robeson's upper bound, so it is considered the most promising polymer among those developed PDMS-MEEP samples. 15PDMS-MEEP thus is the focus material in the following sections. Additionally, separation performance can be affected by the molecular weight of MEEP95, which will be discussed later; the PDMS-MEEP polymers used in the above-mentioned study was MEEP95 with a M_{w} of 891 kDa.

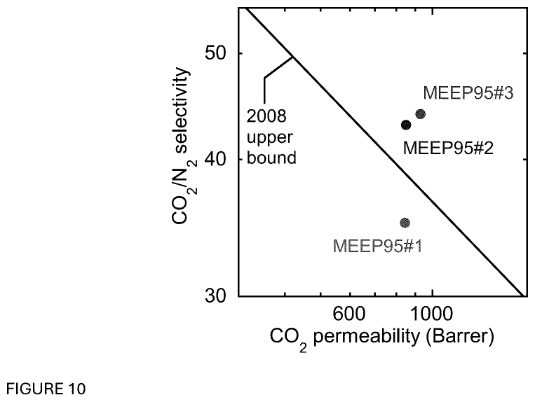

FIG. 10 depicts a graph illustrating a benchmark of pure-gas CO₂/N₂ separation performance of 15PDMS-MEEP bulk films prepared from MEEP95 in three different molecular weights in the Robeson's upper bound plot. Numbers by the data points indicate the batch number of MEEP95. Table 3 illustrates the pure-gas CO₂/N₂ separation performance of 15PDMS-MEEP prepared from MEEP95 with different molecular weights. Generally, MEEP95 with a higher molecular weight (either M_{w} or Mₙ) tends to be more CO₂-selective and permeable, presumably due to more chain entanglement promoting film formation and polymer chain compaction during the membrane casting process. For example, either increasing Mₙ or M_{w} moves the separation performance of 15PDMS-MEEP from below (i.e., MEEP95 #1 data point) to above (i.e., data points for MEEP95 #2 and #3) the upper bound, as shown in FIG. 10.

TABLE 3

| | Weight | Number | | |
|---|---|---|---|---|
| | average | average | Pure-gas | |
| | molecular | molecular | CO₂ | |
| | weight | weight | permeability | CO₂/N₂ |
| Sample | (M_{w}, kDa) | (Mₙ, kDa) | at 23° C. | selectivity* |
| MEEP95#1 | 891 | 400 | 844 | 35 |
| MEEP95#2 | 1040 | 335 | 850 | 43 |
| MEEP95#3 | 880 | 467 | 930 | 44 |

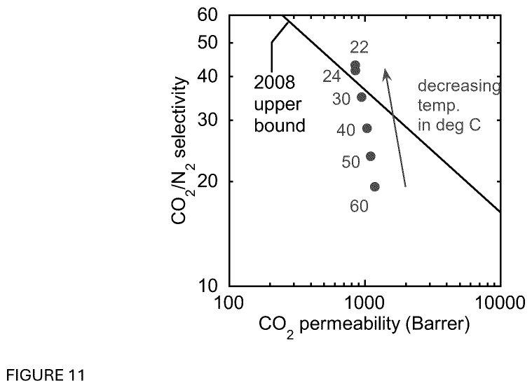

FIG. 11 depicts a graph illustrating a benchmark of mixed-gas CO₂/N₂ separation performance of a 15PDMS-MEEP bulk film in the Robeson's upper bound plot. Specifically, the graph in FIG. 11 shows the mixed-gas CO₂/N₂ separation performance of a MEEP95 #2 based 15PDMS-MEEP bulk film at different temperatures of 22-60° C. Decreasing temperature increases CO₂/N₂ selectivity but decreases CO₂ permeability. At above 30° C., the separation performance is below the upper bound but decreasing temperature to 22-24° C. moves the separation performance beyond the Robeson upper bound. This indicates this PDMS-MEEP material is favorable to be operated at ambient temperatures.

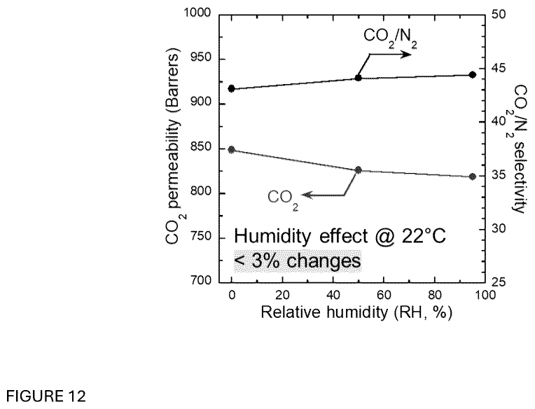

FIG. 12 depicts a graph illustrating the effect of relative humidity (RH, 0-95%) on the mixed-gas CO₂/N₂ separation performance of a MEEP95 #2 based 15PDMS-MEEP bulk film. In a mixed-gas feed (14% CO_{2/86}% N₂) with saturated water vapor (95% RH), the sample still maintained CO₂ permeability at 820 Barrer, only 3% less than the dry gas permeability, suggesting its excellent performance stability against water vapor.

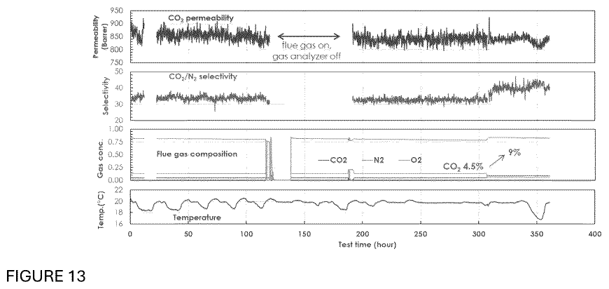

A 15PDMS-MEEP bulk film has been tested in the real natural gas flue gas for a long-term stability study. FIG. 13 depicts a graph plotting CO₂ permeability, CO₂/N₂ selectivity, feed gas composition, and temperature as a function of test time over a course of 360 hours. There are only minor changes in permeability/selectivity due to the feed gas composition changes or environmental temperature fluctuations. Specifically, when the flue gas with a composition of 4.5 mol % CO₂, 78.6 mol % N₂, and 13.3 mol % O₂ (i.e., typical flue gas from a natural gas power plant) was fed to the permeation system at the runtime of 0-310 hours, the sample maintained CO₂ permeability of 850±20 Barrer with CO₂/N₂ selectivity of 33±2. When the flue gas composition was changed 9 mol % CO₂, 84 mol % N₂, and 6 mol % O₂ (i.e., similar to the flue gas composition from a coal power plant) after 310 hours, the CO₂ permeability of the sample remained at ca. 850 Barrer with improved CO₂/N₂ selectivity of 40 due to the less sorption competition of other gases at higher CO₂ concentrations. The trend also agrees with the lab testing, where PDMS-MEEP samples exhibited CO₂/N₂ selectivity of 41 and 44 at 12 mol % and 14 mol % CO₂ feed, respectively.

Overall, the sample shows excellent performance stability over time in practical application conditions.

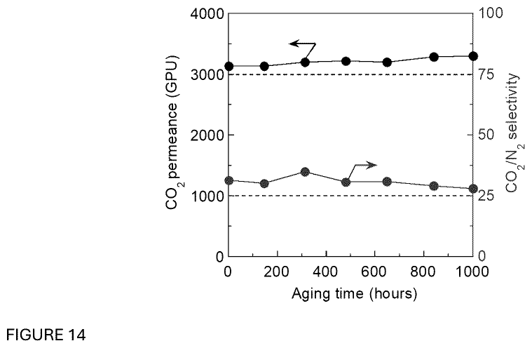

FIG. 14 depicts a graph illustrating performance stability on a wire-wound rod coated 15PDMS-MEEP TFC for 1000 hours in a lab-testing using pure-gas. The sample was tested once every week and stored in ambient conditions while not being tested.

As provided previously, MEEP has excellent gas separation characteristics, especially for CO₂/N₂, as a membrane material, but its poor mechanical stability limits its practical applications. While cross-linking is a common method for improving the mechanical properties of a polymer, there exist three reported approaches to cross-link MEEP polymers in the literature: (i) homolysis of aliphatic C—H of MEEP polymers via exposure to UV, gamma, or other high energy radiation, (ii) peroxide-induced or azobisisobutyronitrile (AIBN)-induced radical coupling of unsaturated side groups of MEEP polymers under heat or UV irradiation, and (iii) using thiol-based cross-linkers to cross-link unsaturated side groups of MEEP polymers via thiol-ene photo reaction under UV. The first two approaches did not work well with resulting cross-linked polymers either remaining tacky or exhibiting much lower gas permeability than expected. The third approach can produce non-tacky, robust, and high-performance bulk films, resulting in gas permeability higher than any previously reported polyphosphazene. However, there are still challenges to convert the promising bulk film properties to high-performance thin film results in this approach, where coating solutions of uncross-linked MEEP and short-chain cross-linkers or their partially cross-linked polymers under UV exposure have poor thin film forming ability. Therefore, it is very difficult to produce ultra-permeable yet defect-free TFC membrane coupons in the third approach, not to mention in large-scale TFC fabrications.

Although organoplatinum compound catalyzed hydrosilylation reaction is not new in polymer chemistry, the adoption of this chemistry to cross-link 2-AP containing MEEP with Si—H containing PDMS for gas separation applications is new. This method is highly effective to covalently cross-link MEEP in both bulk film and thin film states, producing both high-performance stand-alone bulk films and TFC membranes. Unlike the existing three approaches where MEEP polymers are cross-linked after the majority of solvent is removed, our approach allows MEEP to be partially cross-linked with an increased molecular weight and more chain entanglement while it is still dissolved in solution, resulting in greatly enhanced coating ability for thin film fabrications. Here the cross-linked PDMS-MEEP membrane has been demonstrated in a defect-free thin film as small as 120 nm, resulting in CO₂ permeance of up to 4,500 GPU, which is unprecedented and never reported for a membrane containing polyphosphazene.

PDMS by itself is a highly CO₂ permeable polymer with moderate CO₂/N₂ selectivity of 10. The use of Si—H containing PDMS cross-linkers, which are fully converted into PDMS after cross-linking, significantly increases gas permeability of MEEP, resulting in a gas permeability/selectivity combination (930 Barrer and 44-selectivity at 23° C.) better than any polyphosphazene or MEEP-based membrane ever reported in the literature. This is above the 2008 Robeson upper bound, which is unique for a membrane containing polyphosphazene.

Other features that make the PDMS-MEEP membrane uniquely well suited to commercialization and industrial applications include that it exhibits no negative aging properties, meaning that there is no reduction in gas separation performance over time. This is necessary since the lifetime for a gas separation membrane in the field should be greater than 5 years. Also, the gas separation performance has a negligible change when humidity is present in the feed gas. This is important because high levels of humidity are present in flue gas from power generation and industrial sources like steel and cement manufacturing. These two critical features are not true for many of the high performance membranes cited in the literature. For example, high permeability glassy polymers are notorious for physical aging which reduces gas separation performance rapidly with time, and membranes that incorporate porous cage structures like zeolites or metal-organic frameworks (MOFs) are often negatively impacted by any

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

1. A method of synthesizing a cross-linked polymer blend material suitable for gas separation applications, the method comprising:
providing a blend of one or more polyphosphazene polymers containing vinyl groups (—CH═CH₂);
providing a polysiloxane containing reactive silicon-hydrogen (Si—H) bonds; and
cross-linking the polyphosphazene polymer blend and the polysiloxane through a hydrosilylation reaction, forming the cross-linked polymer blend material.

2. The method of claim 1, wherein the polyphosphazene polymer has a structure with at least a pendant R₁ group containing a vinyl (—CH═CH₂) group and at least a pendant group of 2-(2-methoxyethoxy) ethanol (MEE) group:

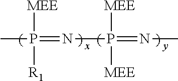

3. The method of claim 2, wherein the molar ratio of the substituent MEE and R₁ groups is y/x>2.

4. The method of claim 2, wherein the molar ratio of the substituent MEE and R₁ groups is greater than 5.

5. The polyphosphazene polymer of claim 2, wherein the vinyl containing R₁ pendant group is 2-allylphenoxy (2-AP) group having a structure:

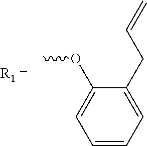

6. The polyphosphazene polymer of claim 2, wherein the MEE group has the structure:

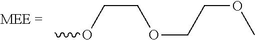

7. The method of claim 1, wherein the polysiloxane has at least a reactive Si—H bond in the structure:

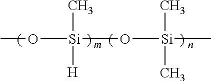

8. The method of claim 1, wherein the polysiloxane includes poly(dimethylsiloxane-co-methylhydrosiloxane).

9. The method of claim 1, wherein the cross-linked polymer blend comprises a cross-linked polyphosphazene-polysiloxane polymer having the structure:

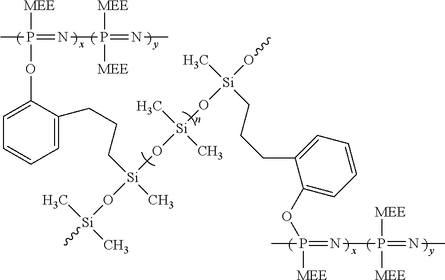

10. The method of claim 1, wherein the hydrosilylation reaction is catalyzed by noble metals selected from the group comprising platinum (Pt), rhodium (Rh), iridium (Ir), and Ruthenium (Ru) catalysts.

11. The hydrosilylation catalysts of claim 10, wherein the Pt catalyst comprises a platinum-divinyltetramethyldisiloxane complex.

12. The method of claim 11, wherein used platinum-divinyltetramethyldisiloxane complex is between about 1 and about 102 ppm levels relative to reaction mixtures.

13. The method of claim 1, wherein the hydrosilylation reaction takes place at between 0° C. and 100° C. for 1 to 1500 minutes.

14. The method of claim 1, wherein the hydrosilylation reaction takes place in an organic solvent selected from the group comprising toluene, benzene, hexane, pentane, iso-octane, chloroform, diethyl ether, tetrahydrofuran, and their mixtures.

15. A method of separating a gas from a gas mixture, comprising:
contacting a cross-linked polyphosphazene-polysiloxane polymer with the gas mixture comprising at least one of CO₂, N₂, O₂ and CH₄; and
allowing at least a portion of the gas mixture to permeate and pass through the polymer, whereby at least a portion of the CO₂/N₂, or CO₂/CH₄, or O₂/N₂ is separated from the gas mixture.

16. The method of claim 15, wherein the cross-linked polyphosphazene-polysiloxane polymer is cast into a polymer membrane form.

17. The method of claim 16, wherein the polymer membrane is a thin film composite membrane that comprises:
at least a cross-linked polyphosphazene-polysiloxane polymer layer as the selective layer; and
at least a porous support layer on the bottom providing the mechanical strength.

18. The method of claim 17 further comprising an intermediate polydimethylsiloxane gutter layer, allowing the formation of a thin selective layer on the porous support layer.

19. The method of claim 17, wherein the selective layer is between 10 nanometers and 10 micrometers.

20. The method of claim 17, wherein the cross-linked polyphosphazene-polysiloxane porous layer is selected from the group comprising a flat-sheet and a hollow fiber.

21. The method of claim 17, wherein the polymer membrane is formed by mixing the polyphosphazene-polysiloxane polymer matrix with a filler particle.

22. The method of claim 21, wherein the filler particle consists of a material selected from the group comprising metal organic framework, carbon molecular sieve, porous organic polymer, graphene, graphene oxide, or silica gel.
